(19) United States
(12) Patent Application Publication
(10) Pub. No.: US 2026/0141251 A1
(43) Pub. Date: May 21, 2026

(54) AI-BASED RESPONSE SYSTEM AND METHOD BASED ON AUTOMATED USER FEEDBACK ANALYSIS AND DYNAMIC TRANSITION BETWEEN FAST-THINKING LLM AND SLOW-THINKING LLM

(71) Applicant: ELECTRONICS AND TELECOMMUNICATIONS RESEARCH INSTITUTE, Daejeon (KR)

(72) Inventors: Euisok Chung, Daejeon (KR); Cheol Ho Kim, Daejeon (KR); Hyun Woo Kim, Daejeon (KR); Hwa Jeon Song, Daejeon (KR); Younghwan SHIN, Daejeon (KR); Jeongmin Yang, Daejeon (KR); Byunghyun Yoo, Daejeon (KR); JUNGHOON LEE, Daejeon (KR)

(21) Appl. No.: 19/389,962

(22) Filed: Nov. 14, 2025

(30) Foreign Application Priority Data
Nov. 18, 2024 (KR) 10-2024-0163984
Nov. 14, 2025 (KR) 10-2025-0172079

(51) Int. Cl. G06N 3/091; G06N 3/0475

(52) U.S. Cl. CPC G06N 3/091; G06N 3/0475

(57) ABSTRACT

Disclosed is a technology which dynamically switches a fast-thinking LLM and a slow-thinking LLM and optimizes the time and accuracy of an AI response through automated user feedback analysis. An AI-based response system provides a prompt response by using the fast-thinking LLM on a user request, and when a complicated query or negative feedback is detected, switches to the slow-thinking LLM to generate a more accurate response. Also, the system asynchronously improves performance of the fast-thinking LLM by using a result of the slow-thinking LLM and user feedback, and thus, decreases the frequency number of model switching and enhances response quality. An AI agent used in sleep consultation is proposed.

### CROSS-REFERENCE TO RELATED APPLICATIONS

This application claims priority under 35 U.S.C. § 119 to Korean Patent Application Nos. 10-2024-0163984, filed on Nov. 18, 2024, and 10-2025-0172079, Nov. 14, 2025, the disclosure of which is incorporated herein by reference in its entirety.

### BACKGROUND

### 1. Field of the Invention

The present disclosure relates to a system and method of responding to a request or a query of a user by using a large language model (LLM).

### 2. Description of Related Art

The reference document list of the present disclosure is shown as in the following [1] to [9]. In the present disclosure, each reference document or the methodology proposed in each reference document may be referred to by a number assigned to each document as follows.
[1] Kahneman, D. (2011). Thinking, Fast and Slow. Farrar, Straus and Giroux.
[2] Evans, J. St. B. T., & Stanovich, K. E. (2013). “Dual-Process Theories of Higher Cognition: Advancing the Debate.” Perspectives on Psychological Science, 8(3), 223-241.
[3] Christakopoulou, K., Mourad, S., & Mataric, M. (2024). “Agents Thinking Fast and Slow: A Talker-Reasoner Architecture.” arXiv 2410.08328.
[4] Shinn, N., Labash, O., & Liu, J. (2023). “Reflexion: An Autonomous Agent with Dynamic Memory and Self-Reflection.” arXiv:2303.11366.
[5] Madaan, A., Touvron, H., Li, X. L., et al. (2023). “Self-Refine: Iterative Refinement with Self-Feedback.” arXiv:2303.17651.
[6] Joachims, T., Swaminathan, A., & de Rijke, M. (2018). “Deep Learning with Logged Bandit Feedback.” International Conference on Learning Representations (ICLR).
[7] Shum, H.-Y., He, X., & Li, D. (2018). “From Eliza to XiaoIce: Challenges and Opportunities with Social Chatbots.” Frontiers of Information Technology & Electronic Engineering, 19(1), 10-26.
[8] Manakul, P., Liusie, A., and Gales, M. J. (2023). “SelfCheckGPT: Zero-resource black-box hallucination detection for generative large language models.” arXiv:2303.08896.
[9] Malinin, A. & Gales, M. (2021). “Uncertainty Estimation in Autoregressive Structured Prediction.” arXiv:2002.07650.

Daniel Kahneman has classified a thinking process of humans into two systems [1]. The system 1 is fast and intuitive ‘Fast-Thinking’, and the system 2 is slow and logical ‘Slow-Thinking’. In artificial intelligence (AI), research which imitates a decision process similar to humans has been done based on the dual process theory [2]. Such a model has fast processed a simple problem and has solved a complicated problem through in-depth analysis.

Particularly, the present disclosure is similar to large language model (LLM)-based multi-agent research [3] based on the research [1]. Here, the agent performs two functions such as dialogue and plan/inference. A difference between the two functions is based on ‘Fast-Thinking’ and ‘Slow-Thinking’ proposed by Daniel Kahneman. Such a system is configured with a talker agent (Fast-Thinking) which fast and intuitively generates a dialogue response and a reasoner agent (Slow-Thinking) which logically performs multi-step inference and planning. Prior art research has described advantages such as the reduction in latency and modularity of a new talker-reasoner architecture and has shown the possibility of actual application by providing a sleep coaching agent as an example. However, the reference research [3] has not proposed a solution method on a transition subject between a fast-thinking module and a slow-thinking module, and moreover, has not proposed a solution method on a performance enhancement subject through additional training of the fast-thinking module.

Moreover, the present disclosure uses a learning method which uses generated data and is similar to a ‘self-reflection’ method where an LLM evaluates and improves its response. Here, a model may autonomously detect and correct the error or inaccuracy of a generated response, and thus, may provide a consistent and accurate result [4][5].

Moreover, the present disclosure also uses research which analyzes user interaction data to improve a service model. Such technology optimizes a service customized for a user request by using a user behavior pattern, a click stream, and a dialogue log, so as to provide a personalized experience and enhance system efficiency [6][7].

### SUMMARY

The present disclosure provides a system which may dynamically switch between a fast-thinking large language model (LLM) and a slow-thinking LLM and an operating method of the system.

In detail, the system may automatically select a more suitable LLM through automated user feedback and real-time monitoring. Also, the system may asynchronously improve the performance of a fast-thinking LLM by using a result of a slow-thinking LLM and user feedback. Accordingly, the system may enhance all of response time and accuracy to increase the satisfaction of a user.

The object of the present disclosure is not limited to the aforesaid, but other objects not described herein will be clearly understood by those skilled in the art from descriptions below.

An operating method of an artificial intelligence (AI)-based response system according to an embodiment of the present disclosure may be a method performed by an AI-based response system responding to a user input by using a large language model (LLM).

The operating method may include: a step of generating a first response corresponding to the user input by using a fast-thinking LLM; a model switch determination step of analyzing the user input and the first response and determining whether to switch to a slow-thinking LLM, based on an analysis result; a step of generating a second response corresponding to the user input by using the slow-thinking LLM and transferring the second response to the user, when a model switches to the slow-thinking LLM; and a step of transferring the first response to the user when a model does not switch to the slow-thinking LLM.

An AI-based response system according to an embodiment of the present disclosure may be a computer system responding to a user input by using an LLM. The AI-based response system may include a processor and a memory configured to store one or more instructions executed by the processor.

The one or more instructions may include: an instruction of generating a first response corresponding to the user input by using a fast-thinking LLM; a model switch determination instruction of analyzing the user input and the first response and determining whether to switch to a slow-thinking LLM, based on an analysis result; an instruction of generating a second response corresponding to the user input by using the slow-thinking LLM and transferring the second response to the user, when a model switches to the slow-thinking LLM; and an instruction of transferring the first response to the user when a model does not switch to the slow-thinking LLM.

An operating method of an artificial intelligence (AI)-based response system responding to a user input by using a large language model (LLM), according to an embodiment of the present disclosure, may include: a step of determining whether a user is a known user; a step of generating a first response corresponding to the user input by using a fast-thinking LLM when the user is the known user; a model switch determination step of analyzing the user input and the first response and determining whether to switch to a slow-thinking LLM, based on an analysis result; a step of generating a second response corresponding to the user input by using the slow-thinking LLM and transferring the second response to the user, when a model switches to the slow-thinking LLM; a step of transferring the first response to the user when a model does not switch to the slow-thinking LLM; a step of extracting a profiling plan, which is a set of intermediate queries for estimating a state of the user, from an interaction memory storing a previous profiling set of the user when the user is an unknown user; a step of receiving answers to the intermediate queries from the user through a user interface and generating a profiling data set which is a set of the intermediate queries and the answers to the intermediate queries; a step of inputting the user input and the profiling data set to the fast-thinking LLM to generate a third response; and a step of outputting the third response through the user interface.

The operating method may further include: a step of evaluating a confidence score of the third response; a step of generating a high-confidence profiling set including an intermediate query and an intermediate answer needed for connecting a gap between the user input and the third response by using the fast-thinking LLM when the confidence score of the third response is greater than a certain threshold value; and a step of storing the high-confidence profiling set in the interaction memory.

The present disclosure may couple a fast-thinking LLM to a slow-thinking LLM to provide a fast and accurate response to a user. When the fast-thinking LLM provides a fast response but has a limitation in a complicated query, an AI-based response system according to embodiments of the present disclosure may automatically switch to the slow-thinking LLM, or may use an interaction between two models, thereby improving performance. Also, the AI-based response system may reflect a result of the slow-thinking LLM in training of the fast-thinking LLM and may repeat a self-reflect process, and thus, may continuously enhance the performance of the fast-thinking LLM. Accordingly, the AI-based response system may optimize all of response time and quality to enhance the satisfaction of a user.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the disclosure and are incorporated in and constitute a part of this application, illustrate embodiments of the disclosure and together with the description serve to explain the principle of the disclosure.

FIG. 1 is a block diagram illustrating a functional configuration of an AI-based response system according to an embodiment of the present disclosure.

FIG. 2 is a block diagram for describing an operating method of an AI-based response system according to an embodiment of the present disclosure.

FIG. 3 is a flowchart for describing an operating method of an AI-based response system according to an embodiment of the present disclosure.

FIG. 4 is a diagram illustrating an embodiment where an AI-based response system is applied to sleep consultation.

FIG. 5 is a flowchart for describing an operating method of an AI-based response system according to an embodiment of the present disclosure.

FIG. 6 is a diagram illustrating an embodiment where an AI-based response system is applied to sleep consultation.

FIG. 7 is a block diagram illustrating a physical configuration of an AI-based response system according to an embodiment of the present disclosure.

### DETAILED DESCRIPTION OF THE INVENTION

The present disclosure may provide an artificial intelligence (AI)-based response system and method based on automated user feedback analysis and dynamic transition between a fast-thinking large language model (LLM) and a slow-thinking LLM.

The AI-based response system may switch the fast-thinking LLM to the slow-thinking LLM so as to enhance a user experience when the fast-thinking LLM for a small-scale or fast response has a limitation in an answer, or may improve performance through an interaction between two models. The AI-based response system may select an optimal model, based on user feedback and real-time monitoring, and may continuously enhance the capability of the fast-thinking LLM through a self-reflect process.

The advantages, features and aspects of the present invention will become apparent from the following description of the embodiments with reference to the accompanying drawings, which is set forth hereinafter. The present invention may, however, be embodied in different forms and should not be construed as limited to the embodiments set forth herein. Rather, these embodiments are provided so that this disclosure will be thorough and complete, and will fully convey the scope of the present invention to those skilled in the art. The terms used herein are for the purpose of describing particular embodiments only and are not intended to be limited to example embodiments. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. Hereinafter, embodiments of the present invention will be described in detail with reference to the accompanying drawings.

While terms such as “first” and “second,” etc., may be used to describe various components, such components must not be understood as being limited to the above terms. It will be understood that when an element is referred to as being “connected to” another element, it can be directly connected to the other element or intervening elements may also be present.

In contrast, when an element is referred to as being “directly connected to” another element, no intervening elements are present. In addition, unless explicitly described to the contrary, the word “comprise” and variations such as “comprises” or “comprising,” will be understood to imply the inclusion of stated elements but not the exclusion of any other elements. Also, other expressions describing relationships between components such as “˜between”, “immediately˜between” or “adjacent to ˜” and “directly adjacent to ˜” may be construed similarly.

In describing embodiments, description on technology which is well known in the technical field of the present invention and is directly irrelevant to the present invention is omitted. This is for more clearly transferring subject matters of the present invention by omitting an unnecessary description in order not to obscure subject matters of the present invention.

Hereinafter, embodiments of the invention will be described in detail with reference to the accompanying drawings. In describing the invention, to facilitate the entire understanding of the invention, like numbers refer to like elements throughout the description of the figures, and a repetitive description on the same element is not provided.

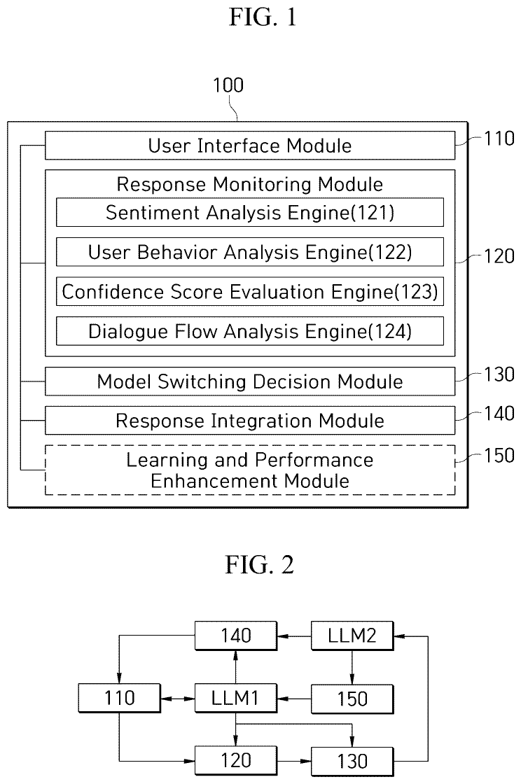

FIG. 1 is a block diagram illustrating a functional configuration of an AI-based response system 100 according to an embodiment of the present disclosure.

As illustrated in FIG. 1, the AI-based response system 100 according to an embodiment of the present disclosure may include a user interface module 110, a response monitoring module 120, a model switching decision module 130, and a response integration module 140, and moreover, may further include a learning and performance enhancement module 150.

Moreover, as illustrated in FIG. 1, the response monitoring module 120 may include a sentiment analysis engine 121, a user behavior analysis engine 122, a confidence score evaluation engine 123, and a dialogue flow analysis engine 124.

The elements of the AI-based response system 100 according to an embodiment of the present disclosure are not limited to the embodiment of FIG. 1, and depending on the case, may be added, changed, or deleted.

An operating method of the AI-based response system 100 of FIG. 1 may be described with reference to FIGS. 2 to 4.

FIG. 2 is a block diagram for describing an operating method of an AI-based response system according to an embodiment of the present disclosure.

The user interface module 110 may function as a counter through which a user inputs a query or a request. In the present disclosure, a query of the user, a request of the user, and a reaction of the user to a response (a first response) of the fast-thinking LLM LLM1 may be referred to as a ‘user input’. That is, the user input may include a query of the user, a request of the user, and/or a reaction of the user.

The user input which is input through the user interface module 110 may be transferred to the fast-thinking LLM LLM1. That is, the user interface module 110 may transfer the user input to the fast-thinking LLM LLM1.

For reference, the fast-thinking LLM LLM1 may be equipped in the AI-based response system 100, or may be equipped in an LLM server which is outside the AI-based response system 100.

The fast-thinking LLM LLM1 may provide a prompt response to a user input. Herein, a response generated by the fast-thinking LLM LLM1 may be referred to as a ‘first response’. The first response may include only one response, but is not limited thereto and may include a plurality of responses. For example, when a multi-turn interaction is performed between the user and the fast-thinking LLM LLM1, the first response may include a plurality of responses.

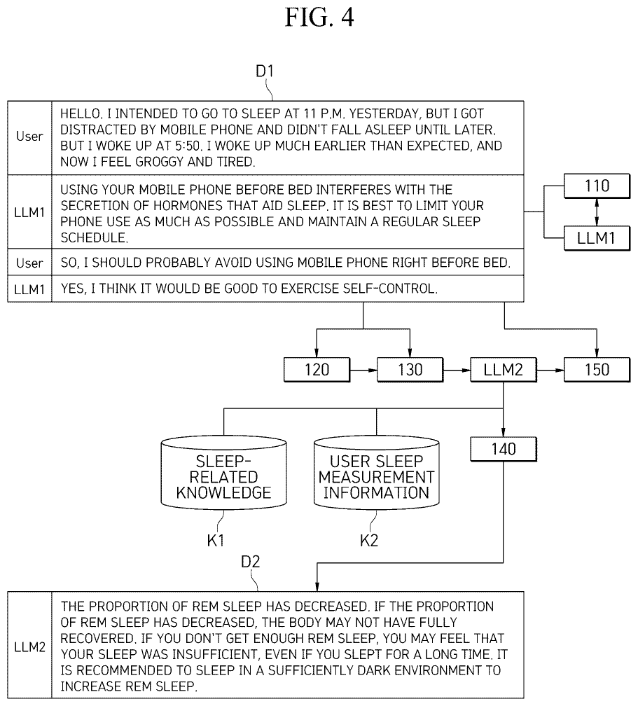

The first response generated by the fast-thinking LLM LLM1 may be transferred to the response monitoring module 120 and the model switching decision module 130. The response monitoring module 120 may receive the user input from the user interface module 110, for analysis. For example, as in FIG. 4, the response monitoring module 120 may receive a first dialogue D1 including the user input and the first response from the user interface module 110 and the fast-thinking LLM LLM1 and may analyze the first dialogue D1. The first dialogue D1 may be time-serial data of the user input and the first response and may include start time and end time information about each of the user input and the first response. Accordingly, the response monitoring module 120 may determine a duration (a time up to an end time from a start time) of each turn and a latency (a time up to a start time of a next turn from an end time of a previous turn) up to a next time, which are included in the first dialogue.

As described above, the response monitoring module 120 may analyze the user input and/or the first response by using the sentiment analysis engine 121, the user behavior analysis engine 122, the confidence score evaluation engine 123, and the dialogue flow analysis engine 124.

The sentiment analysis engine 121 may determine a sentiment state of the user, based on a user reaction included in the user input. For example, the sentiment analysis engine 121 may automatically analyze a positive sentiment or a negative sentiment of the user by natural language processing (NLP) technology, based on the user input including the user reaction. When the negative sentiment of the user is detected, the sentiment analysis engine 121 may transfer the negative sentiment to the model switching decision module 130, and as the negative sentiment of the user is detected, the model switching decision module 130 may automatically switch to the slow-thinking LLM LLM2.

Moreover, the user behavior analysis engine 122 may analyze a behavior pattern of the user, based on the first dialogue D1. The user behavior analysis engine 122 may monitor an interaction pattern of the user in real time in the middle of consultation of the fast-thinking LLM LLM1. That is, the user behavior analysis engine 122 may extract the interaction pattern of the user in the first dialogue D1. For example, the user may repeat the same query, or may increase a time (herein referred to as ‘user's response latency’, ‘user's response time’, or ‘turn transition time’) up to a next input after a response of the fast-thinking LLM LLM1 (more than a threshold time), or may analyze a behavior such as fast deviation (a deviation duration is less than a threshold value). When such a behavior is detected, the model switching decision module 130 may determine that the user does not satisfy a dialogue with the fast-thinking LLM LLM1 and may switch to the slow-thinking LLM LLM2 which has highly advanced.

Moreover, the confidence score evaluation engine 123 may calculate a confidence score (reliability) of the first response generated by the fast-thinking LLM LLM1. The confidence score evaluation engine 123 may calculate the confidence score of the first response generated by the fast-thinking LLM LLM1. When the confidence score is less than or equal to the threshold value, the model switching decision module 130 may automatically switch to the slow-thinking LLM LLM2, and thus, may allow a more accurate answer to be provided.

For reference, the confidence score may be calculated through various methods. For example, a known method of estimating the uncertainty of an LLM may be used. In detail, Manakul (2023)[8] has proposed a method of calculating a confidence score, based on generation consistency, and Malinin & Gales (2021)[9] has proposed a method of accumulating prediction entropy to evaluate the uncertainty of an LLM.

Finally, the dialogue flow analysis engine 124 may analyze a context and a flow of a dialogue appearing in the first dialogue D1. The dialogue flow analysis engine 124 may analyze the context and flow of the first dialogue D1 to determine a part which the user confuses or does not understand. Herein, the part may be referred to as a ‘comprehension gap’. Here, the comprehension gap may denote a case where there is a mismatch between a thing known by a user and a thing understood by an LLM in the same context. The dialogue flow analysis engine 124 may extract a part, where a comprehension gap occurs, of the first dialogue D1 and may transfer the extracted part to the model switching decision module 130. In this case, the model switching decision module 130 may switch to the slow-thinking LLM LLM2 capable of more complicated inference and may issue a command to allow the slow-thinking LLM LLM2 to focus on a comprehension gap occurrence part to generate a second response.

The response monitoring module 120 may transfer an analysis result of each of the engines 121 to 124, included in the response monitoring module 120, to the model switching decision module 130.

In an embodiment of the present disclosure, the model switching decision module 130 may input an analysis result of the response monitoring module 120 to an ensemble model to perform synthetic determination. That is, the model switching decision module 130 may determine whether to switch the fast-thinking LLM LLM1 to the slow-thinking LLM LLM2, based on an output of the ensemble model. Such a method may be a method which individually operates a plurality of different analysis models (for example, a sentiment analysis model used by the sentiment analysis engine 121, a user behavior analysis model used by the user behavior analysis engine 122, a confidence score evaluation model used by the confidence score evaluation engine 123, and a dialogue flow analysis model used by the dialogue flow analysis engine 124), and then, couples outputs of the models to use a result of the coupling in final decision. Through such a process, the model switching decision module 130 may couple merits of several models to obtain more accurate and high-confidence decision and may differently assign weights to obtain an optimal combination, based on a characteristic of each model.

As described above, the model switching decision module 130 may determine whether to switch the fast-thinking LLM LLM1 to the slow-thinking LLM LLM2, based on an analysis result (for example, a sentiment state analysis result, a behavior pattern analysis result, the reliability of the first response, and a context and flow analysis result of a dialogue) of the response monitoring module 120.

A process of generating a final response may be changed based on the determination of the model switching decision module 130. When it is determined that the model switching decision module 130 does not switch to the slow-thinking LLM LLM2 (‘switch undesired’), the first response may be transferred as the final response to the user. On the other hand, when it is determined that the model switching decision module 130 switches to the slow-thinking LLM LLM2 (‘switch desired’), the model switching decision module 130 may transfer, to the slow-thinking LLM LLM2, a response generation request to the user input. For reference, the slow-thinking LLM LLM2 may be equipped in the AI-based response system 100, or may be equipped in an LLM server which is outside the AI-based response system 100.

The slow-thinking LLM LLM2 may generate more accurate and detailed response than the fast-thinking LLM LLM1 on the user input through complicated inference, based on external knowledge (for example, relevant information and knowledge stored in a remote data storage). Herein, a response generated by the slow-thinking LLM LLM2 may be referred to as a ‘second response’. The second response may include only one response, or may include a plurality of responses. The response integration module 140 may receive the second response generated by the slow-thinking LLM LLM2.

The response integration module 140 may finally generate or design a response (hereinafter referred to as a ‘final response’) which is to be transferred to the user. The final response may be transferred to the user by the user interface module 110.

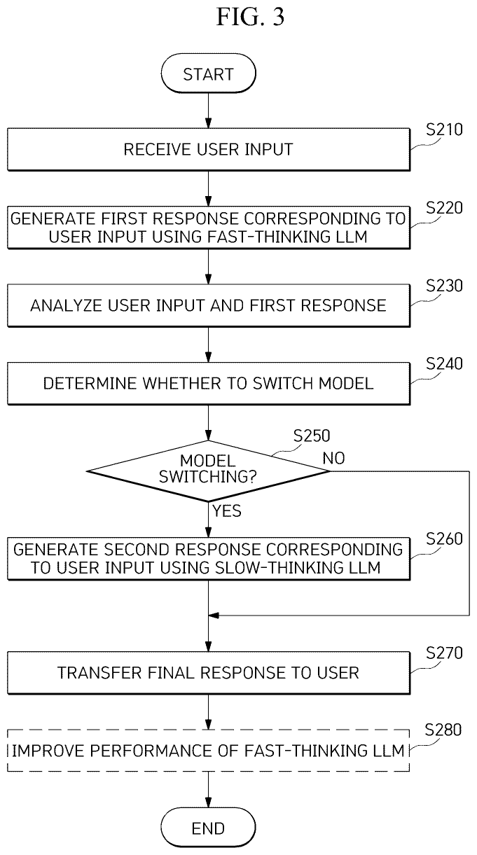

FIG. 3 is a flowchart for describing an operating method of an AI-based response system according to an embodiment of the present disclosure.

Referring to FIG. 3, an operating method of the AI-based response system 100 according to an embodiment of the present disclosure may include steps S210 to S280. The operating method illustrated in FIG. 3 may be an embodiment, and the steps of the operating method according to embodiments of the present disclosure are not limited to the embodiment of FIG. 3, and depending on the case, a step may be added, changed, or deleted.

An operation of the AI-based response system 100 has been described in detail with reference to FIG. 2, and thus, its detailed description is omitted.

Step S210 may be a step of receiving a user input.

The AI-based response system 100 may receive the user input through the user interface module 110. As described above, the user input may include a query of the user, a request of the user, and/or a reaction of the user to a response of an LLM.

Step S220 may be a step of generating a first response corresponding to the user input by using the fast-thinking LLM LLM1.

The user interface module 110 may transfer the user input to the fast-thinking LLM LLM1, and the fast-thinking LLM LLM1 may generate a prompt response (a first response) on the user input and may provide the first response to the AI-based response system 100.

Step S230 may be a step of analyzing the user input and the first response, in order to determine whether to switch a model.

The response monitoring module 120 may perform sentiment analysis of the user, behavior analysis of the user, confidence score evaluation of the first response, and context and flow analysis of a dialogue appearing in the user input and the first response, on the user input and the first response, and thus, may generate an analysis result.

The analysis result may include a result (sentiment analysis result) of determining a sentiment state of the user based on the user reaction included in the user input, a behavior pattern of the user appearing in the first response of the fast-thinking LLM LLM1, a confidence score of the first response, and a context and flow of the dialogue appearing in the user input and the first response.

Moreover, the analysis result may further include an output obtained by inputting, to the ensemble model, a sentiment state of the user determined, the behavior pattern of the user appearing in the user input and the first response, the confidence score of the first response, and the context and flow of the dialogue appearing in the user input and the first response, based on the user reaction included in the user input.

Step S240 may be a step of determining whether to switch the fast-thinking LLM LLM1 to the slow-thinking LLM LLM2.

The model switching decision module 130 may determine whether to switch the fast-thinking LLM LLM1 to the slow-thinking LLM LLM2, based on an analysis result of the response monitoring module 120.

Step S250 may be a step of branching based on whether to switch a model.

When the model switches, step S260 may be performed, and otherwise, the response integration module 140 may design the first response to a final response and may perform step S270.

Step S260 may be a step of generating a second response to the user input by using the slow-thinking LLM LLM2 according to switching of a model.

When a model switches to the slow-thinking LLM LLM2, the model switching decision module 130 may transfer the user input and/or the first response to the slow-thinking LLM LLM2 to allow the slow-thinking LLM LLM2 to generate the second response which corresponds to the user input and is a more accurate response. The response integration module 140 may receive the second response from the slow-thinking LLM LLM2 and may design the second response to a final response.

Step S270 may be a step of transferring the final response to the user.

The response integration module 140 may transfer the final response to the user. For example, the response integration module 140 may transfer the final response (the first response when a model does not switch, or the second response when a model switches) to the user through the user interface module 110 or the communication device.

Step S280 may be a step of improving the performance of the fast-thinking LLM LLM1 through training of the fast-thinking LLM LLM1.

The learning and performance enhancement module 150 may train the fast-thinking LLM LLM1 by using the user input, the second response, and/or the first response as learning data. The learning and performance enhancement module 150 may improve the performance of the fast-thinking LLM LLM1, and thus, the weight of role of the slow-thinking LLM LLM2 may continuously decrease.

The operating method the AI-based response system 100 described above has been described with reference to the flowchart illustrated in FIG. 3. To provide a simple description, the method is illustrated as a series of blocks and has been described, but the present disclosure is not limited to the order of the blocks, and some blocks and the other blocks may be executed simultaneously or in order which differs from the illustration and description of the present disclosure, and various other branches and flow paths and the orders of blocks for accomplishing the same or similar results may be implemented. Also, all blocks illustrated for implementing the method described in the present disclosure may not be needed.

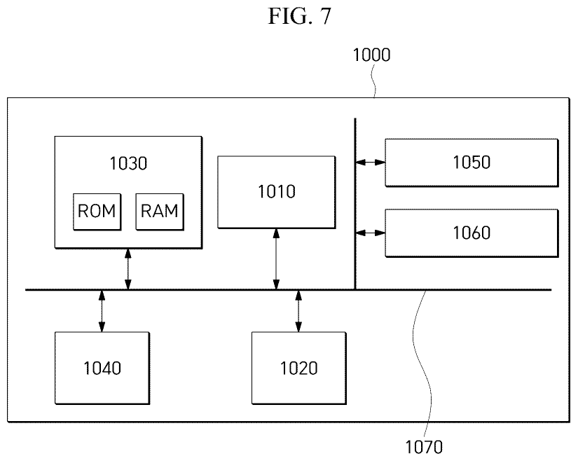

In the above description of FIG. 3, based on an implementation example of the present disclosure, each step may be further divided into additional steps, or may be combined into fewer steps. Also, depending on the case, some steps may be omitted, and the order of steps may be changed. Despite other omitted descriptions, the descriptions of FIGS. 1, 2, and 4 to 7 may be applied to the description of FIG. 3. Also, the descriptions of FIGS. 2 to 6 may be applied to the description of FIG. 1 or 7.

FIG. 4 is a diagram illustrating an embodiment where an AI-based response system is applied to sleep consultation. That is, FIG. 4 is an embodiment where a sleep coaching AI agent is implemented by using the AI-based response system 100.

The user may perform sleep-related consultation with the fast-thinking LLM LLM1 through the user interface module 110. Here, the response monitoring module 120 may collect consultation content (first response) provided by the fast-thinking LLM LLM1 and the user input and may store the collected content in an internal storage. The first dialogue D1 may include the user input (‘User’) and the first response of the fast-thinking LLM LLM1. The first dialogue D1 may be transferred to the response monitoring module 120 and the model switching decision module 130 by the user interface module 110 and the fast-thinking LLM LLM1.

The model switching decision module 130 may determine whether the slow-thinking LLM LLM2 participates or not, based on the first dialogue D1. The slow-thinking LLM LLM2 may refer to sleep-related knowledge associated with current sleep consultation content through a sleep-related knowledge base K1. Also, the slow-thinking LLM LLM2 may access sleep measurement information K2 about the user to refer to recent sleep and behavior-related information about the user. The slow-thinking LLM LLM2 may generate the second response D2 which is additional consultation content, based on information extracted in the sleep-related knowledge base K1, the sleep measurement information K2 about the user, and the first dialogue D1.

With respect to a specific time, the response integration module 140 may process the information D1 and D2 collected and generated up to a corresponding time to generate a final response and may transfer the final response to the user. The specific time may be a time at which consultation between the user and the fast-thinking LLM LLM1 is completed, or may be a time at which the generation of the second response D2 by the slow-thinking LLM LLM2 is completed.

Moreover, the learning and performance enhancement module 150 may store, as learning data, the first dialogue D1 and a consultation result (second response D2) of the slow-thinking LLM LLM2 and may periodically train the fast-thinking LLM LLM1 by using the learning data. Accordingly, the learning and performance enhancement module 150 may gradually enhance sleep consultation knowledge of the fast-thinking LLM LLM1, thereby reducing the use of the slow-thinking LLM LLM2 which consumes the high cost.

In an embodiment of the present disclosure, the slow-thinking LLM LLM2 may be a high-cost LLM API, and the fast-thinking LLM LLM1 may be a low-cost LLM API or an open source LLM.

In a case which trains the low-cost LLM API, the learning and performance enhancement module 150 may use indirect access such as prompt engineering, cache and reuse strategy, or meta learning.

In a case which trains the open source LLM, the learning and performance enhancement module 150 may use knowledge distillation, fine-tuning, adaptive learning, or continual learning technology.

According to an embodiment of the present disclosure, the learning and performance enhancement module 150 may perform training of the fast-thinking LLM LLM1 by using external knowledge K1 and K2 used by the slow-thinking LLM LLM2.

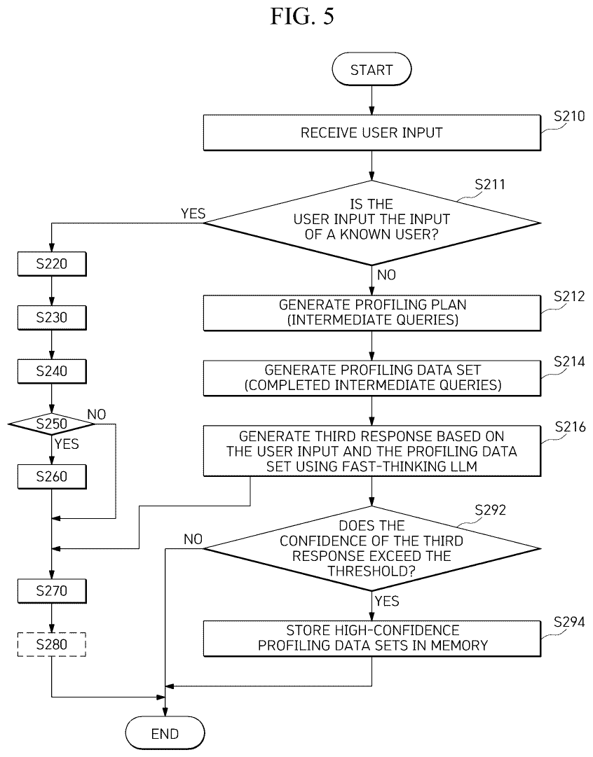

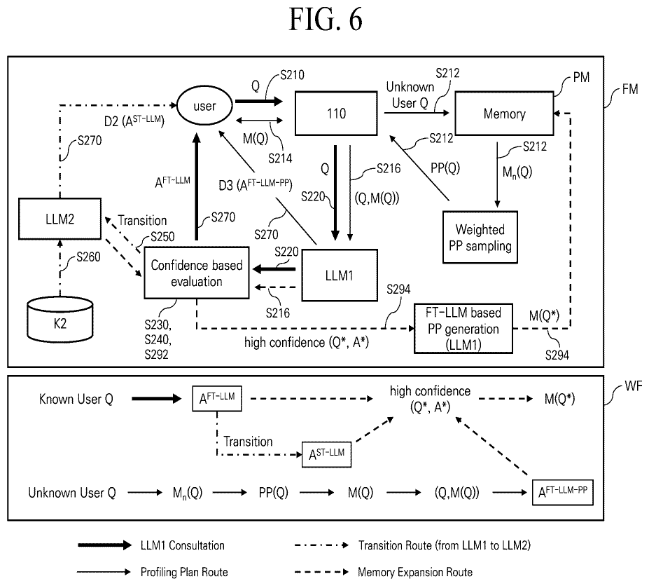

FIG. 5 is a flowchart for describing an operating method of an AI-based response system according to an embodiment of the present disclosure, and FIG. 6 is a diagram illustrating an embodiment where an AI-based response system is applied to sleep consultation. FIGS. 5 and 6 illustrate an embodiment of an operating method of the AI-based response system 100 which may respond by using an intermediate query when an input of a user including no personal data (for example, personal sleep data) (hereinafter referred to as an ‘unknown user’) is received. Hereinafter, for example, the embodiment will be described with reference to sleep consultation.

The embodiment of FIG. 5 illustrates the extension of the embodiment of FIG. 3 to provide a response having a high confidence score to a user input of an unknown user. Therefore, the operating method of FIG. 5 may include the operating method of FIG. 3.

Referring to FIG. 5, the operating method of the AI-based response system 100 according to an embodiment of the present disclosure may include steps S210 to S294. An element of FIG. 6 corresponding to each step of FIG. 5 may be referred to by a reference numeral.

The operating method of the AI-based response system 100 illustrated in FIG. 5 may be based on one embodiment, and thus, each step of the operating method of the AI-based response system 100 according to the present disclosure is not limited to the embodiment illustrated in FIG. 5, and depending on the case, a step may be added, changed, or deleted.

As described above with reference to FIGS. 2 and 3, in a known user where sleep measurement information K2 about a user is secured, the AI-based response system 100 may generate a second response D2 which is an in-depth analysis response by using the slow-thinking LLM LLM2, based on the sleep-related knowledge base K1 and the sleep measurement information K2 about the user.

On the other hand, based on an input Q of in an unknown user where there is no sleep measurement information K2 about the user, the AI-based response system 100 may estimate a similar profile from an interaction memory PM storing an interaction history associated with the user to generate a profiling plan PP(Q), and based thereon, may allow the fast-thinking LLM LLM1 to generate a third response D3 (A^{FT-LLM-PP}) which is a personalized consultation response.

Moreover, when a confidence score of the third response D3 is high, the AI-based response system 100 may generate a profiling data set M(Q*) which is a set of an intermediate query and an answer by using the fast-thinking LLM LLM1, based on a pair (Q*, A*) of a high-confidence user input and an answer, and then, may store the profiling data set M(Q*) in the interaction memory PM and may continuously improve the accuracy of consultation and personalization performance by using the profiling data set M(Q*) in subsequent consultation.

Hereinafter, an embodiment of an operating method of the AI-based response system 100 capable of responding to a query of an unknown user with a high confidence will be described. Steps S210 to S280 have been described in detail with reference to FIGS. 2 and 3, and thus, their detailed descriptions are omitted.

Step S211 may be a step of determining whether the user input Q received in step S210 is an input of the known user where the sleep measurement information K2 about the user is secured. In the present embodiment, the user input Q may be a sleep-related query or a consultation request, which is input from the user. For example, the user input Q may be a query such as “I went to bed late last night. Do you have any tips for a sound sleep (or for sleeping better)?”.

When the user is the known user, the response monitoring module 120 may perform step S220, and otherwise, may perform S212.

Step S212 may be a step of generating a profiling plan.

The profiling plan PP(Q) may denote a set of intermediate queries which are generated for estimating a state of the unknown user. In the present disclosure, the profiling plan PP(Q) may denote a profile structure of an initial state where a response is empty.

The profiling plan PP(Q) may be a set of intermediate queries iqᵢ and empty responses Φ and may be expressed as the following Equation 1.

$$P P ( Q ) = \{ ( i {q}_{1} , ∅ ) , ( iq 2 , ∅ ) , … , ( {iq}_{n} , ∅ ) \} \qquad [ Equation 1 ]$$

In Equation 1, Φ may denote an empty response and may denote that an intermediate answer iaᵢ to the intermediate query iqᵢ is not yet determined.

The response monitoring module 120 may calculate a similarity between a query included in the user input Q and a previous query Q′ stored in the interaction memory PM including a completed profiling set M(Q′), in order to generate the profiling plan PP(Q). Also, the response monitoring module 120 may select n number of upper profiling sets Mₙ(Q) having a high similarity score with a query input by the user from among the profiling set M(Q′).

Moreover, the response monitoring module 120 may stochastically sample the intermediate query i_{q} from the profiling set Mₙ(Q) to generate the profiling plan PP(Q). In this case, a sampling criterion may be a similarity. That is, the response monitoring module 120 may randomly sample the intermediate query i_{q} from the profiling set Mₙ(Q), and in this case, may assign a high weight to a previous query Qᵢ having a high similarity.

Step S214 may be a step of generating a profiling data set M(Q) where an intermediate query is completed.

The response monitoring module 120 may transfer the intermediate query iqᵢ included in the profiling plan PP(Q) to the user through the user interface module 110, may receive the answer iaᵢ to each intermediate query iqᵢ from the user to complete the profiling plan PP(Q), thereby generating the profiling data set M(Q).

The profiling data set M(Q) may be expressed as the following Equation 2.

$$M ( Q ) = \{ ( {iq}_{1} , {ia}_{1} ) , ( {iq}_{2} , {ia}_{2} ) , … , ( {iq}_{n} , {ia}_{n} ) \} \qquad [ Equation 2 ]$$

Step S216 may be a step of generating the third response D3 (A^{FT-LLM-PP}) by using the fast-thinking LLM LLM1, based on the user input Q and the profiling data set M(Q).

The response monitoring module 120 may input the user input Q and the profiling data set M(Q) to the fast-thinking LLM LLM1 to generate the third response D3 (A^{FT-LLM-PP}).

Subsequently, step S270 may be performed, and the response integration module 140 may transfer the third response D3, which is a final response, to the user. Also, steps S292 to S294 may be performed for enhancing response performance on the unknown user.

Step S292 may be a step of evaluating the third response D3.

To expand the interaction memory PM, the present step may be a step of determining whether to generate a high-confidence profiling data set M(Q*), based on the third response D3.

To evaluate step S292, in FIGS. 2 and 3, a methodology which has been used in analysis of the first response D1 may be applied for determining whether to switch a model. That is, the response monitoring module 120 may perform sentiment analysis of the user, behavior analysis of the user, confidence score evaluation of the third response D3, and context and flow analysis of a dialogue appearing in the user input and the third response D3, on the user input Q and the third response D3, and thus, may generate an analysis result.

In the embodiment of FIG. 5, confidence score evaluation has been applied as an evaluation method on the third response D3. When the third response D3 has a confidence score which is greater than a threshold value, the response monitoring module 120 may perform step S294, and otherwise, may store the profiling data set M(Q) in the interaction memory PM, or may end a process.

Step S294 may be a step of generating the high-confidence profiling data set M(Q*) and storing the high-confidence profiling data set M(Q*) in the interaction memory PM.

When the third response D3 has the confidence score which is greater than the threshold value, the response monitoring module 120 may respectively designate the user input Q and the third response D3 to a high-confidence query Q* and a high-confidence answer A*.

Moreover, the response monitoring module 120 may generate the high-confidence profiling data set M(Q*) from a high-confidence query-answer pair (Q*, A*) by using the fast-thinking LLM LLM1 and may store the high-confidence profiling data set M(Q*) in the interaction memory PM. In this process, the fast-thinking LLM LLM1 may generate an interactive chain of thought between the high-confidence query Q* and the high-confidence answer A*. That is, the fast-thinking LLM LLM1 may generate an intermediate query and an answer needed for bridging (connecting) a gap between an original query Q* and a final answer A*, and thus, may complete the high-confidence profiling data set M(Q*). For example, in this process, an LLM prompt which may be input to the fast-thinking LLM LLM1 by the response monitoring module 120 may be “Generate two or three intermediate queries and corresponding short answers that are necessary for the query Q* to reach the answer A*”.

FIG. 6 is a block diagram illustrating a data flow of the operating method illustrated in FIG. 5. FIG. 6 may include a framework FM for performing adaptive sleep consultation by using an LLM and a workflow WF which varies based on whether the sleep measurement information K2 about a user is stored.

In FIG. 6, a thick solid line represents a portion where consultation is performed by using the fast-thinking LLM LLM1, and a dash-single dotted line represents a portion where the fast-thinking LLM LLM1 switches to the slow-thinking LLM LLM2, and consultation is performed by the slow-thinking LLM LLM2.

Moreover, a solid line represents a portion where consultation is performed by the fast-thinking LLM LLM1, based on the profiling plan PP(Q), and a dotted line represents a portion where the high-confidence profiling data set M(Q*) is generated from the high-confidence query-answer pair (Q*, A*) and is stored in the interaction memory PM, and thus, the interaction memory PM expands based on information obtained by an unknown user.

Hereinabove, an embodiment of the operating method of the AI-based response system 100 on a query of an unknown user has been described with reference to FIGS. 5 and 6.

Features of the AI-based response system 100 obtained the embodiment will be described below.
(1) Non-dependence on personal information: Customized consultation may be performed based on a query pattern and context of a user in a situation where there is no personal sleep data.
(2) Inference based on profiling memory: A state of an unknown user may be estimated, and an initial consultation direction may be set, with reference to a past similar user profile.
(3) Adaptive switching: When a confidence score of consultation is low, the fast-thinking LLM LLM1 may switch to the slow-thinking LLM LLM2, and precise analysis may be performed.
(4) Continuous self-growing based on interaction memory: A high-confidence query-answer pair may be stored in a memory in a consultation process, and thus, the memory may expand, thereby gradually enhancing response performance on an unknown user.

FIG. 7 is a block diagram illustrating a physical configuration of an AI-based response system according to an embodiment of the present disclosure.

The AI-based response system 100 according to an embodiment of the present disclosure may be implemented as a type of computer system 1000 illustrated in FIG. 7.

For reference, unlike FIG. 7, the AI-based response system 100 according to an embodiment of the present disclosure may be implemented as software or a hardware type such as field programmable gate array (FPGA) or application specific integrated circuit (ASIC).

Referring to FIG. 7, the computer system 1000 may include at least one of at least one processor 1010, a memory 1030, an input interface device 1050, an output interface device 1060, and a storage device 1040, which communicate with each other through a bus 1070. The computer system 1000 may further include a communication device 1020 coupled to a network. The processor 1010 may be central processing unit (CPU), or may be a semiconductor device which executes instructions stored in the memory 1030 and/or the storage device 1040. The memory 1030 and the storage device 1040 may each include various types of volatile or non-volatile storage mediums. For example, the memory 1030 may include read-only memory (ROM) and random access memory (RAM). In an embodiment of the present disclosure, the memory 1030 may be disposed in or outside the processor 1010 and may be connected to the processor 1010 through various means well known. The memory 1030 may include various types of volatile or non-volatile storage mediums, and for example, may include ROM and RAM.

Therefore, an embodiment of the present disclosure may be implemented as a method implemented in a computer, or may be implemented as a non-transitory computer-readable medium storing an instruction executable by a computer. In an embodiment of the present disclosure, when executed by the processor 1010, computer-readable instructions may perform the method according to at least one aspect of the present disclosure.

The communication device 1020 may transmit or receive a wired signal or a wireless signal.

Moreover, the method according to embodiments of the present disclosure may be implemented in the form of program instructions capable of being executed through various computer means and may be recorded in a computer-readable recording medium.

The computer-readable recording medium may individually include a program instruction, a data file, and a data structure, or may include a combination thereof. The program instruction recorded in the computer-readable medium may be specially designed and configured for embodiments of the present disclosure, or may be known to those skilled in the art in the field of computer software and may be available. The computer-readable recording medium may include a hardware device configured to store and execute a program instruction. For example, the computer-readable recording medium may include a magnetic storage medium such as a hard disk, a floppy disk, and a magnetic tape, an optical recording medium such as CD-ROM and digital versatile disk (DVD), read-only memory (ROM), random access memory (RAM), and flash memory. The program instruction may include a machine language code, such as being created by a compiler, and a high-level language code capable of being executed by a computer through an interpreter.

The processor 1010 may execute one or more computer-readable instructions stored in the memory 1030 or the storage device 1040, and thus, may generate a final response to a user input.

The one or more instructions may include an instruction which generates a first response corresponding to the user input by using the fast-thinking LLM LLM1, an instruction (an instruction of determining whether to switch a model) which analyzes the user input and the first response and determines whether to switch to the slow-thinking LLM LLM2, based on an analysis result, an instruction which generates a second response corresponding to the user input by using the slow-thinking LLM LLM2 when the fast-thinking LLM LLM1 switches to the slow-thinking LLM LLM2 and transfers the second response to the user, and an instruction which transfers the first response, generated by the fast-thinking LLM LLM1, to the user when a model does not switch to the slow-thinking LLM LLM2.

The analysis result may include a result (sentiment analysis result) of determining a sentiment state of the user based on a user reaction included in the user input, a behavior pattern of the user appearing in the user input and the first response of the fast-thinking LLM LLM1, a confidence score of the first response, and a context and flow of a dialogue appearing in the user input and the first response.

Moreover, the analysis result may further include an output obtained by inputting, to an ensemble model, a sentiment state of the user determined, a behavior pattern of the user appearing in the user input and the first response, a confidence score of the first response, and a context and flow of a dialogue appearing in the user input and the first response, based on a user reaction included in the user input.

Moreover, the one or more instructions may further include an instruction which trains the fast-thinking LLM LLM1 by using the user input, the first response, and the second response as learning data.

The present disclosure may couple a fast-thinking LLM to a slow-thinking LLM to provide a fast and accurate response to a user. When the fast-thinking LLM provides a fast response but has a limitation in a complicated query, an AI-based response system according to embodiments of the present disclosure may automatically switch to the slow-thinking LLM, or may use an interaction between two models, thereby improving performance. Also, the AI-based response system may reflect a result of the slow-thinking LLM in training of the fast-thinking LLM and may repeat a self-reflect process, and thus, may continuously enhance the performance of the fast-thinking LLM. Accordingly, the AI-based response system may optimize all of response time and quality to enhance the satisfaction of a user.

It will be apparent to those skilled in the art that various modifications and variations can be made in the present invention without departing from the spirit or scope of the inventions. Thus, it is intended that the present invention covers the modifications and variations of this invention provided they come within the scope of the appended claims and their equivalents.

What is claimed is:

1. An operating method of an artificial intelligence (AI)-based response system responding to a user input by using a large language model (LLM), the operating method comprising:
generating a first response corresponding to the user input by using a fast-thinking LLM;
analyzing the user input and the first response to determine whether to switch to a slow-thinking LLM, based on an analysis result;
generating a second response corresponding to the user input by using the slow-thinking LLM and transferring the second response to the user, when a model switches to the slow-thinking LLM; and
transferring the first response to the user when a model does not switch to the slow-thinking LLM.

2. The operating method of claim 1, wherein the analysis result comprises a result of determining a sentiment state of the user, based on a user reaction included in the user input.

3. The operating method of claim 1, wherein the analysis result comprises a behavior pattern of the user appearing in the user input and the first response.

4. The operating method of claim 1, wherein the analysis result comprises a confidence score of the first response.

5. The operating method of claim 1, wherein the analysis result comprises a context and flow of a dialogue appearing in the user input and the first response.

6. The operating method of claim 1, wherein the analysis result comprises an output obtained by inputting, to an ensemble model, a sentiment state of the user determined, a behavior pattern of the user appearing in the user input and the first response, a confidence score of the first response, and a context and flow of a dialogue appearing in the user input and the first response, based on a user reaction included in the user input.

7. The operating method of claim 1, further comprising training the fast-thinking LLM by using the user input, the first response, and the second response as learning data.

8. An artificial intelligence (AI)-based response system responding to a user input by using a large language model (LLM), the AI-based response system comprising:
a processor; and
a memory configured to store one or more instructions executed by the processor,
wherein the one or more instructions comprise:
an instruction of generating a first response corresponding to the user input by using a fast-thinking LLM;
a model switch determination instruction of analyzing the user input and the first response and determining whether to switch to a slow-thinking LLM, based on an analysis result;
an instruction of generating a second response corresponding to the user input by using the slow-thinking LLM and transferring the second response to the user, when a model switches to the slow-thinking LLM; and
an instruction of transferring the first response to the user when a model does not switch to the slow-thinking LLM.

9. The AI-based response system of claim 8, wherein the analysis result comprises a result of determining a sentiment state of the user, based on a user reaction included in the user input.

10. The AI-based response system of claim 8, wherein the analysis result comprises a behavior pattern of the user appearing in the user input and the first response.

11. The AI-based response system of claim 8, wherein the analysis result comprises a confidence score of the first response.

12. The AI-based response system of claim 8, wherein the analysis result comprises a context and flow of a dialogue appearing in the user input and the first response.

13. The AI-based response system of claim 8, wherein the analysis result comprises an output obtained by inputting, to an ensemble model, a sentiment state of the user determined, a behavior pattern of the user appearing in the user input and the first response, a confidence score of the first response, and a context and flow of a dialogue appearing in the user input and the first response, based on a user reaction included in the user input.

14. The AI-based response system of claim 8, further comprising an instruction of training the fast-thinking LLM by using the user input, the first response, and the second response as learning data.

15. An operating method of an artificial intelligence (AI)-based response system responding to a user input by using a large language model (LLM), the operating method comprising:
determining whether a user is a known user;
generating a first response corresponding to the user input by using a fast-thinking LLM when the user is the known user;
analyzing the user input and the first response and to determine whether to switch to a slow-thinking LLM, based on an analysis result;
generating a second response corresponding to the user input by using the slow-thinking LLM and transferring the second response to the user, when a model switches to the slow-thinking LLM;
transferring the first response to the user when a model does not switch to the slow-thinking LLM;
extracting a profiling plan, which is a set of intermediate queries for estimating a state of the user, from an interaction memory storing a previous profiling set of the user when the user is an unknown user;
receiving answers to the intermediate queries from the user through a user interface and generating a profiling data set which is a set of the intermediate queries and the answers to the intermediate queries;
inputting the user input and the profiling data set to the fast-thinking LLM to generate a third response; and
outputting the third response through the user interface.

16. The operating method of claim 15, further comprising:
evaluating a confidence score of the third response;
generating a high-confidence profiling set including an intermediate query and an intermediate answer needed for connecting a gap between the user input and the third response by using the fast-thinking LLM when the confidence score of the third response is greater than a certain threshold value; and
storing the high-confidence profiling set in the interaction memory.
